(19) United States
(12) Patent Application Publication
(10) Pub. No.: US 2026/0192200 A1
(43) Pub. Date: Jul. 9, 2026

(54) METHOD AND DEVICE FOR CONTROLLING SOUND IN GAME, ELECTRONIC DEVICE AND NON-TRANSITORY STORAGE MEDIUM

(71) Applicant: NETEASE (HANGZHOU) NETWORK CO., LTD., Hangzhou, Zhejiang (CN)

(72) Inventors: Zeting LONG, Guangzhou, Guangdong (CN); Yu PENG, Guangzhou, Guangdong (CN); Wei XU, Hangzhou, Zhejiang (CN)

(73) Assignee: NETEASE (HANGZHOU) NETWORK CO., LTD., Hangzhou, Zhejiang (CN)

(21) Appl. No.: 19/132,790

(22) PCT Filed: May 24, 2023
(86) PCT No.: PCT/CN2023/096123

§ 371 Date: May 23, 2025

(30) Foreign Application Priority Data
Nov. 24, 2022 (CN) 202211484890.9

(51) Int. Cl. A63F 13/54; A63F 13/58

(52) U.S. Cl. CPC A63F 13/54; A63F 13/58

(57) ABSTRACT

The present disclosure provides a method for controlling a sound in a game, including: determining a target skill parameter of a controlled virtual object, wherein the target skill parameter is configured to be determined based on a state parameter of the controlled virtual object entering a specified game state, and the specified game state includes at least one of the controlled virtual object entering a specified sub-scene in the game scene or the controlled virtual object performing a specified game action; in response to a sound playback instruction for a target sound, determining a sound playback parameter of the target sound based on the target skill parameter, wherein the target sound is from the game scene or a first virtual object in the game scene; and controlling, based on the sound playback parameter, a terminal device to play the target sound.

### CROSS-REFERENCE TO RELATED APPLICATION

The present disclosure is a U.S. National Stage Application of International Application No. PCT/CN2023/096123, filed on May 24, 2023, which is based upon and claims the priority to the Chinese Patent Application NO. 202211484890.9, entitled “METHOD AND DEVICE FOR CONTROLLING SOUND IN GAME, AND ELECTRONIC DEVICE”, filed on Nov. 24, 2022, the entire contents of which are incorporated herein by reference for all purposes.

### TECHNICAL FIELD

The present disclosure relates to the field of game technologies, and more particularly to a method and device for controlling a sound in a game, and an electronic device.

### BACKGROUND

Sound effects are typically provided in game projects, such as environmental sounds (e.g., wind and birdsong), action sounds, skill release sounds, etc. Players can adjust the volume of the sound effects through settings panel, and can also set a control method for the action sounds. During gameplay, the presentation of the sound effects is controlled according to setting parameters in the settings panel.

It should be noted that the information disclosed in the background section above is only used to enhance the understanding of the background of the present disclosure, and therefore may include information that does not constitute the prior art known to those skilled in the art.

### SUMMARY

In a first aspect, embodiments of the present disclosure provide a method for controlling a sound in a game, wherein a graphical user interface is provided by a terminal device, the graphical user interface includes a scene screen of a game scene, a controlled virtual object is located in the game scene, and the controlled virtual object is controlled through the terminal device; and the method includes: determining a target skill parameter of the controlled virtual object, wherein the target skill parameter is configured to be determined based on a state parameter of the controlled virtual object entering a specified game state, and the specified game state includes the controlled virtual object entering a specified sub-scene in the game scene, and/or the controlled virtual object performing a specified game action; in response to a sound playback instruction for a target sound, determining a sound playback parameter of the target sound based on the target skill parameter, wherein the target sound is from the game scene or a first virtual object in the game scene, and the first virtual object includes the controlled virtual object or a virtual object other than the controlled virtual object in the game scene; and controlling, based on the sound playback parameter, the terminal device to play the target sound.

In a second aspect, embodiments of the present disclosure provide an electronic device, including a processor and a memory, wherein the memory stores machine-executable instructions that can be executed by the processor, and the processor executes the machine-executable instructions to implement the method for controlling the sound in the game as descried above.

In a third aspect, embodiments of the present disclosure provide a non-transitory machine-readable storage medium having machine-executable instructions stored thereon, wherein the machine-executable instructions, when invoked and executed by a processor, cause the processor to implement the method for controlling the sound in the game as descried above.

### BRIEF DESCRIPTION OF THE DRAWINGS

In order to illustrate the technical solutions in specific embodiments of the present disclosure or in the related arts more clearly, the accompanying drawings that need to be used in the description of the specific embodiments or the related arts are briefly described below, and it is obvious that the drawings in the following description are some embodiments of the present disclosure, and for those skilled in the art, other drawings can be obtained according to these drawings without involving any inventive effort.

FIG. 1 is a flowchart of a method for controlling a sound in a game provided by an embodiment of the present disclosure;

FIG. 2 is a flowchart of another method for controlling a sound in a game provided by an embodiment of the present disclosure;

FIG. 3 is a schematic structural diagram of a device for controlling a sound in a game provided by an embodiment of the present disclosure; and

FIG. 4 is a schematic structural diagram of an electronic device provided by an embodiment of the present disclosure.

### DETAILED DESCRIPTION

In order to make objectives, technical solutions and advantages of embodiments of the present disclosure clearer, the technical solutions of the present disclosure will be clearly and completely described below in conjunction with the accompanying drawings. Obviously, the described embodiments are part of the embodiments of the present disclosure, rather than all of the embodiments. Based on the embodiments in the present disclosure, all other embodiments obtained by those skilled in the art without creative work are within the protection scope of the present disclosure.

In the related arts, a player can adjust the presentation of a sound effect via a setting panel in a game. When setting parameters of the sound effect are the same, sound effects obtained by different players in the game are the same, that is, sounds made by virtual objects controlled by the players in a game scene when performing actions, and the heard sounds made by other virtual objects in the game scene are the same. Therefore, the auditory level in the game scene is simple.

Based on the above, embodiments of the present disclosure provide a method and device for controlling a sound in a game, and an electronic device, which can be applied to sound control in various types of games, for example, to control a sound playback intensity and a sound playback type of a sound such as a firearm sound and a footstep sound in a combat game, etc.

The method for controlling the sound in the game in an embodiment of the present disclosure can be run on a local terminal device or a server. When the method for controlling the sound in the game is run on the server, the method can be implemented and executed based on a cloud interaction system, and the cloud interaction system includes the server and a client device.

In an implementation, various cloud applications, such as cloud gaming, can be run in the cloud interaction system. Taking the cloud gaming as an example, the cloud gaming refers to a game mode based on cloud computing. In an operation mode of cloud gaming, an operating body of a game program and a main body of the game screen presentation are separated. The storage and operation of the method for controlling the sound in the game are completed on the cloud gaming server. The client device is used for receiving and sending data and presenting the game screen. For example, the client device can be a display device with data transmission function close to the user side, such as a mobile terminal, a TV, a computer, a handheld computer, etc.; but the cloud gaming server in the cloud is used for information processing. When playing the game, a player operates the client device to send an operation instruction to the cloud gaming server. The cloud gaming server runs the game according to the operation instruction, encodes and compresses the game screen and other data, and returns it to the client device through the network. Finally, the client device decodes and outputs the game screen and other data.

In an implementation, taking a game as an example, a local terminal device stores a game program and is used to present a game screen. The local terminal device is used to interact with the player through a graphical user interface, that is, the game program is conventionally downloaded and installed through the electronic device and run. The local terminal device may provide the graphical user interface to the player in a variety of ways, for example, the graphical user interface may be rendered and displayed on a display screen of the terminal, or provided to the player through a holographic projection. For example, the local terminal device may include the display screen and a processor, the display screen is used to present the graphical user interface, the graphical user interface includes a game screen, and the processor is used to run the game, generate the graphical user interface, and control the display of the graphical user interface on the display screen.

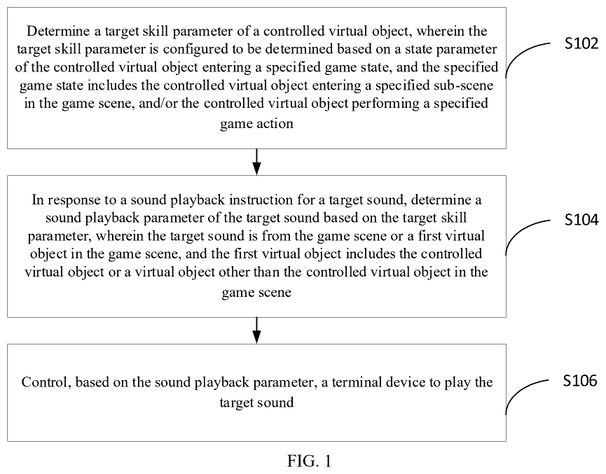

In an implementation, embodiments of the present disclosure provide a method for controlling a sound in a game. A graphical user interface is provided by a terminal device, and the terminal device may be the local terminal device mentioned above, or may be the client device in the cloud interaction system mentioned above. The graphical user interface includes a scene screen of a game scene, a controlled virtual object is located in the game scene, and the controlled virtual object is controlled through the terminal device. As shown in FIG. 1, the method includes steps S102 to S106.

In the step S102, a target skill parameter of the controlled virtual object is determined, the target skill parameter is configured to be determined based on a state parameter of the controlled virtual object entering a specified game state, and the specified game state includes that the controlled virtual object enters a specified sub-scene in the game scene, and/or the controlled virtual object performs a specified game action.

Various game sound effects are provided in the game scene. Some sound effects can create the environment atmosphere in the game scene, such as environmental sound effects, scene sound effects, etc. The environmental sound effects are mainly used to create the atmosphere and emotional tone of the scene or game level, such as sounds of wind and rain. The scene sound effects include sound effects when the virtual object interacts with virtual objects in the game scene, such as a sound of burning trees, sounds of opening boxes and opening doors, etc. Some sound effects can enhance the combat impact experience in the game, such as skill sound effects, action sound effects, etc. The skill sound effects can include normal attacks, such as sounds of slashing, whipping, and shooting, and can also include a sound of skill activation and release. The action sound effects are, for example, sounds of normal walking, running, and jumping of the virtual object, a sound of vaulting over cover, and sounds of raising, aiming, and leaning for weapons, etc.

The player can control the virtual object through the terminal device to perform activities such as fighting and exploring in the game scene. During the game, the player can hear the game sound effect as mentioned above, which is an auditory skill of the controlled virtual object. In the embodiment, in order to enhance the auditory experience of the player in the game, the target skill parameter of the controlled virtual object can be set to achieve different auditory experiences and effects of different players for the same game sound effect in the game.

Specifically, the target skill parameter can be determined in advance according to the state parameter of the controlled virtual object entering the specified game state, and the specified game state includes at least one of the controlled virtual object entering the specified sub-scene in the game scene or the controlled virtual object performing the specified game action. That is, the controlled virtual object enters the specified sub-scene in the game scene, and can complete a corresponding task or do some training in the specified sub-scene, and then the state parameter is determined according to the performance of the controlled virtual object in the specified sub-scene, or the state parameter can be determined according to factors such as the number of times or time that the controlled virtual object performs the specified action, or the state parameter is determined according to factors such as the performance of the controlled virtual object in the specified sub-scene and the number of times or time that the controlled virtual object performs the specified action.

Then, the target skill parameter of the controlled virtual object is determined according to the state parameter of the controlled virtual object entering the specified game state. The target skill parameter can be used to indicate an auditory ability level of the controlled virtual object. For example, the larger the parameter, the higher the auditory ability, the farther and smaller the sound can be heard, and the higher the ability to filter the noise sound. The target skill parameter can be realized by a skill level, a skill experience value, etc.

In the step S104, in response to a sound playback instruction for a target sound, a sound playback parameter of the target sound is determined based on the target skill parameter, the target sound is from the game scene or a first virtual object in the game scene, and the first virtual object includes the controlled virtual object or a virtual object other than the controlled virtual object in the game scene.

The target sound in the sound playback instruction for the target sound may come from the game scene, for example, the environmental sound effect in the game scene, or from the first virtual object in the game scene, and the first virtual object includes the controlled virtual object or the virtual object other than the controlled virtual object in the game scene. That is, the target sound may also come from the controlled virtual object in the game scene, such as the footstep sound made by the controlled virtual object when walking, etc., and may also come from the virtual object other than the controlled virtual object in the game scene, such as the footstep sound made by a teammate or an enemy when walking in the game, etc.

In response to the sound playback instruction for the target sound, the sound playback parameter of the target sound can be determined according to the target skill parameter, and the sound playback parameter can be used to control a loudness level during the target sound playback. It is relatively easy to understand that in different game scenarios, demands for the game sound effects are different. For example, in non-offensive game scenarios, game sound effects that create an environmental atmosphere may be more needed to allow the player to quickly enter the game scenario; while for offensive scenarios, game sound effects that enhance the combat impact experience in the game are needed. On the one hand, the skill sound effects can enhance the authenticity of the combat, and on the other hand, the action sound effects can facilitate the player to judge a position of the enemy, so as to better avoid attacks or accurately attack the enemy. Therefore, the loudness level of the target sound playback not only affects the player's sense of involvement in the atmosphere of the game, but also affects the player's survival and performance in the game scene and other aspects.

It should be noted that multiple game sound effects can be played simultaneously during the game. For example, the environmental sound effect can be played continuously after entering the game. As the game plot develops, the playback of the scene sound effects, the action sound effects, the skill sound effects, etc. can be added. Therefore, the target sound can be one sound or multiple sounds. Alternatively, the player can also choose to turn off the playback of certain game sound effects according to the player's needs or preferences.

In the embodiment, the sound playback parameter of the target sound is determined through the target skill parameter, so that for different players, if target skill parameters of their corresponding controlled virtual objects are different, the playback parameters of the target sound will also be different, thereby achieving different auditory experiences and effects of different players for the same sound effect in the game.

In the step S106, the terminal device is controlled, based on the sound playback parameter, to play the target sound.

Specifically, when the sound playback parameter of the target sound is determined according to the target skill parameter of the controlled virtual object, the sound playback parameter may include sound playback loudness, a sound playback type, etc. The terminal device is controlled, according to the sound playback parameter, to play the target sound.

In the method for controlling the sound in the game as described above, the target skill parameter of the controlled virtual object is determined, the target skill parameter is configured to be determined based on the state parameter of the controlled virtual object entering the specified game state, and the specified game state includes that the controlled virtual object enters the specified sub-scene in the game scene, and/or the controlled virtual object performs the specified game action; in response to the sound playback instruction for the target sound, the sound playback parameter of the target sound is determined based on the target skill parameter, the target sound is from the game scene or the first virtual object in the game scene, and the first virtual object includes the controlled virtual object or the virtual object other than the controlled virtual object in the game scene; and the terminal device is controlled, based on the sound playback parameter, to play the target sound. In this way, the target skill parameter is determined according to the state parameter of the controlled virtual object entering the specified game state, so that different players can have different target skill parameters, and the target skill parameter is associated with the sound playback parameter of the target sound, so that different players hear different sound effects for the same sound, which enriches the presentation of the sound effect, realizes a differentiated auditory experience, and improves the game experience of the player.

The following embodiments provide a specific implementation for updating the target skill parameter of the controlled virtual object.

The specified game state includes that the controlled virtual object enters the specified sub-scene in the game scene, and the specified sub-scene includes a preset skill training sub-scene. The controlled virtual object is controlled to enter the skill training sub-scene; in response to the controlled virtual object entering the skill training sub-scene, a skill training parameter of the controlled virtual object is obtained based on a state of the controlled virtual object in the skill training sub-scene; and the target skill parameter of the controlled virtual object is updated based on the skill training parameter.

In an implementation, the specified game state includes that the controlled virtual object enters the specified sub-scene in the game scene, and the specified sub-scene may the preset skill training sub-scene. In the preset skill training sub-scene, the controlled virtual object can perform various skill trainings to improve the ability of various skills. For example, the controlled virtual object can perform auditory skill training to improve the auditory skill. In addition, there can also be comprehensive training that can train multiple skill abilities at the same time.

In actual implementation, the player controls the controlled virtual object to enter the skill training sub-scene, and then the skill training parameter of the controlled virtual object is obtained according to the state of the controlled virtual object in the skill training sub-scene. A parameter value of the skill training parameter can reflect the quality of the skill training result of the controlled virtual object. For example, if the training result of the controlled virtual object in the skill training sub-scene is very good, then the parameter value of the skill training parameter of the controlled virtual object is relatively high. Similarly, if the training result of the controlled virtual object in the skill training sub-scene is poor, then the parameter value of the skill training parameter of the controlled virtual object is relatively low.

In addition, the state of the controlled virtual object in the skill training sub-scene can also be referenced against a training time of the controlled virtual object in the skill training sub-scene. When the controlled virtual object is trained in the skill training sub-scene, it can obtain skill points, which can be used to improve the skill. The longer the controlled virtual object is trained in the skill training sub-scene, the more skill points will be accumulated, which will be more helpful for skill improvement. In actual implementation, the skill point can be collected as the controlled virtual object trains, and then the collected skill points are allocated to various skills in a point assignment mechanism. That is, when the skill points are allocated, the skill points can be allocated to the skills that the player likes or needs according to the player's wishes. When the player wants to improve the auditory skill, the skill points allocated to the auditory skill can be all converted into an experience value of the auditory skill, that is, converted at a ratio of 1:1. As the experience value of the auditory skill increases, the parameter value of the skill training parameter of the controlled virtual object will also increase.

Then, the target skill parameter of the controlled virtual object is updated according to the skill training parameter. Specifically, when the parameter value of the skill training parameter of the controlled virtual object is high and reaches a certain level, it means that the training result of the controlled virtual object is very good, the auditory skill of the controlled virtual object will be improved, and the parameter value of the target skill parameter will also be improved. When the parameter value of the skill training parameter of the controlled virtual object is low, it means that the training result of the controlled virtual object is poor, and the auditory skill of the controlled virtual object may not be improved.

The following embodiments provide another specific implementation for updating the target skill parameter of the controlled virtual object.

The specified game state includes that the controlled virtual object performs the specified game action, and in response to an action control operation, the controlled virtual object is controlled to perform the specified game action; and an action parameter of the controlled virtual object for performing the specified game action is obtained, and the target skill parameter of the controlled virtual object is updated based on the action parameter, the action parameter includes an action duration and/or the number of times of the action.

The specified game action includes stealth movement and/or crouch movement. In another implementation, the specified game state may include the controlled virtual object performing the specified game action, and the specified game action may include at least one of the stealth movement or the crouch movement. The stealth movement means that the controlled virtual object eliminates the footstep sound while moving, and the crouch movement means that the controlled virtual object moves in a crouching posture. The specified game action is mainly used to reduce the loudness of the sound made by the controlled virtual object in the game scene, thereby concealing itself and reducing the risk of being discovered by the enemy, which can also be used as a training mode.

The action control operation can be implemented in a variety of ways, such as long pressing, clicking, etc., and the movement control operation can also be triggered by a keyboard control. When the player performs the action control operation, the controlled virtual object can be controlled to perform the specified game action, that is, the stealth movement, or the crouch movement, or the stealth movement and the crouch movement. Further, the action parameter of the controlled virtual object for performing the specified game action is obtained, and the action parameter may include an action duration, the number of times of the action, and the action duration and the number of times of the action. Then, the target skill parameter of the controlled virtual object is updated according to the action parameter. That is, the target skill parameter of the controlled virtual object is updated according to the performance of the player in performing the specified game action.

The following embodiments continue to illustrate the specific implementation for updating the target skill parameter of the controlled virtual object.

The target skill parameter includes an auditory skill level. In response to the controlled virtual object entering the specified game state, an auditory experience value of the controlled virtual object is updated; and in response to the auditory experience value reaching a preset experience value threshold, the auditory skill level of the controlled virtual object is updated.

In actual implementation, the target skill parameter may include the auditory skill level. The auditory skill level of the controlled virtual object may start from level 0. When the controlled virtual object enters the specified game state and completes the corresponding training, it may obtain the auditory experience value, and then the auditory experience value of the controlled virtual object is updated. When the auditory experience value reaches the preset experience value threshold, the auditory skill level of the controlled virtual object may be updated until the auditory skill level of the controlled virtual object reaches an upper limit of the level. For example, if the preset experience threshold is 100, an initial auditory skill level of the controlled virtual object is level 0. When the controlled virtual object enters the specified sub-scene in the specified game scene and completes the training, it may obtain the auditory experience value. When the auditory experience value accumulates to 100, the auditory skill level of the controlled virtual object will be upgraded to level 1, and so on, until the auditory skill level of the controlled virtual object is upgraded to the upper limit of the level.

It should be noted that when the auditory skill level is improved, the preset experience threshold may be the same or different. For example, the preset experience threshold may increase as the auditory skill level increases. For example, when the auditory skill level of the controlled virtual object is improved from level 0 to level 1, the preset experience threshold is 100, and when the auditory skill level is improved from level 1 to level 2, the preset experience threshold may be 100 or greater than 100.

In addition, the auditory skill level may also be associated with a character level of the controlled virtual object, that is, a speed of improving the auditory skill level or the upper limit of the auditory skill level can be affected by the character level of the controlled virtual object. For example, the higher the character level of the controlled virtual object, the faster the improvement of the auditory skill level, or the higher the character level of the controlled virtual object, the greater the value of the upper limit of the auditory skill level.

In the embodiment, the auditory skill level of the controlled virtual object is updated according to the training result of the player in the specified game state, so that auditory skill levels of different players in the game are different, and the game experience at different auditory levels can be further obtained.

The following embodiments provide a specific implementation for determining sound playback loudness of the target sound.

The sound playback parameter includes sound playback loudness. The sound playback instruction for the target sound is received, and a sound attribute of the target sound is determined, the sound attribute indicates a sound source and/or a sound type of the target sound; and sound playback loudness of the target sound is determined based on the sound attribute of the target sound and the target skill parameter.

In actual implementation, the sound playback parameter may include the sound playback loudness. When the sound playback instruction for the target sound is received, the sound attribute of the target sound is first determined, and the sound attribute may indicate at least one of the sound source or the sound type of the target sound. The sound source may include the game scene, the virtual object in the game scene, etc., and the sound type may include the environmental sound effect, the environmental noise, the action sound effect, the skill sound effect, the event sound effect, etc.

Then, the sound playback loudness of the target sound is determined according to the sound attribute of the target sound and the target skill parameter. Specifically, the sound playback loudness of the target sound can also be determined in combination with a game plot where the controlled virtual object is currently located. For example, in a shooting game, when there is an enemy around the controlled virtual object, the player needs to be able to clearly hear the enemy's footstep sound. In this case, the sound playback loudness of the environmental sound effect from the game scene needs to be reduced, and the sound playback loudness of the action sound effect of the virtual object from the game scene needs to be increased. A amplitude of the reduction of the sound playback loudness of the environmental sound effect from the game scene and a amplitude of the increase of the sound playback loudness of the action sound effect of the virtual object from the game scene are determined by the target skill parameter of the controlled virtual object. Therefore, the sound playback loudness of the target sound is jointly determined by the sound attribute of the target sound and the target skill parameter.

The target skill parameter includes the auditory skill level. The following embodiments respectively introduce specific implementations for determining the sound playback loudness of the target sound based on the sound attribute and the auditory skill level.

In an implementation, a sound type of the target sound indicated by the sound attribute is an environmental noise of the game scene, and the higher the auditory skill level, the lower the sound playback loudness of the target sound.

Specifically, when the sound type of the target sound indicated by the sound attribute is the environmental noise in the game, that is, the target sound will interfere with the player's hearing. In this case, the higher the auditory skill level of the controlled virtual object, the lower the sound playback loudness of the target sound, thereby reducing the auditory interference of the environmental noise to the player corresponding to the controlled virtual object with the high auditory skill level.

In another implementation, the sound type of the target sound indicated by the sound attribute is an action sound of the controlled virtual object, and the higher the auditory skill level, the lower the sound playback loudness of the target sound.

Specifically, when the sound type of the target sound indicated by the sound attribute is the action sound of the controlled virtual object, that is, the action sound made by the controlled virtual object, in this case, the higher the auditory skill level, the lower the sound playback loudness of the target sound. In other words, when the auditory skill level of the controlled virtual object is higher, the sound playback loudness of the action sound made by will be lower, which reduces the interference to the player's hearing and makes the player's action sound more concealed and not easily discovered by other players.

The following embodiments provide another specific implementation for determining the sound playback loudness of the target sound.

A distance parameter between a sound source of the target sound and the controlled virtual object is determined, and the sound source includes the virtual object other than the controlled virtual object in the game scene. If the distance parameter is within a distance range corresponding to the target skill parameter, it is determined that the sound playback loudness of the target sound is first loudness. If the distance parameter is outside the distance range corresponding to the target skill parameter, it is determined that the sound playback loudness of the target sound is zero.

In actual implementation, the sound playback loudness of the target sound can also be determined according to the distance parameter between the sound source of the target sound and the controlled virtual object. The sound source of the target sound can be the virtual object other than the controlled virtual object in the game scene. Specifically, the distance parameter between the virtual object that makes the target sound in the game scene and the controlled virtual object can be determined. If the distance parameter is within the distance range corresponding to the target skill parameter, the sound playback loudness of the target sound is determined to be the first loudness, and the first loudness can be negatively correlated with the distance parameter. That is, when the distance parameter is within the distance range corresponding to the target skill parameter, the distance parameter being smaller means that the virtual object corresponding to the target sound source is closer to the controlled virtual object, and in this case, the player hears the louder sound; and the distance parameter being larger means that the virtual object corresponding to the target sound source is farther from the controlled virtual object, and in this case, the player hears the smaller sound. If the distance parameter exceeds the distance range corresponding to the target skill parameter, it means that the player cannot hear the target sound, so the sound playback loudness of the target sound can be determined to be zero.

The following embodiments introduce a factor that affects the first loudness when the distance parameter is within the distance range corresponding to the target skill parameter.

In an implementation, if the distance parameter is within the distance range corresponding to the target skill parameter, the smaller the distance parameter, the higher the first loudness. It is relatively easy to understand that when the distance parameter is within the distance range corresponding to the target skill parameter, that is, the target sound is within an audible distance range of the player, in this case, the smaller the distance parameter is, the closer the location of the source of the target sound is to the controlled virtual object, and the higher the first loudness is.

The target skill parameter includes the auditory skill level. The following embodiments continue to introduce another factor that affects the first loudness and a relationship between the target skill parameter and its corresponding distance range.

In another implementation, if the distance parameter is within the distance range corresponding to the target skill parameter, the higher the auditory skill level, the higher the first loudness. That is, when the distance parameter is within the distance range corresponding to the target skill parameter, that is, the target sound is within the audible distance range of the player, in the case of the same distance parameter, that is, the distance between the location of the source of the target sound and the controlled virtual object is the same, the higher the auditory skill level, the higher the first loudness. For example, when the distance parameter is the same, the corresponding first loudness when the auditory skill level of the controlled virtual object is level 6 is lower than the corresponding first loudness when the auditory skill level of the controlled virtual object is upgraded to level 7.

In the embodiment, in the game scene, when other virtual objects make sounds, for multiple players within the audible distance range, players corresponding to virtual objects with different auditory skill levels hear the target sound at the different loudness, thereby creating a differentiated auditory experience.

Furthermore, the higher the auditory skill level, the larger the distance range corresponding to the target skill parameter; and/or, the distance range corresponding to the target skill parameter is associated with a completion status of a preset task corresponding to the auditory skill level.

Specifically, the distance range corresponding to the target skill parameter can be associated with at least one of the auditory skill level or the completion status of the preset task corresponding to the auditory skill level. In an implementation, when the auditory skill level is higher, the distance range corresponding to the target skill parameter will be larger, and correspondingly, when the auditory skill level is lower, the distance range corresponding to the target skill parameter will be smaller. For example, the distance range corresponding to the target skill parameter when the auditory skill level is level 2 will be smaller than the distance range corresponding to the target skill parameter when the auditory skill level is level 3. That is, when the auditory skill level is higher, the player's audible distance, that is, the distance within which the sound can be heard will be farther. In another implementation, the preset task corresponding to the auditory skill level can be set, and each auditory skill level corresponds to the preset task. The distance range corresponding to the target skill parameter is determined according to the status of the controlled virtual object completing the preset task, that is, regardless of the auditory skill level of the controlled virtual object, as long as the preset task is completed, the distance range corresponding to the target skill parameter can be increased.

In addition, the distance range corresponding to the target skill parameter can also be jointly determined by the auditory skill level and the status of completing the preset task. In actual implementation, a level value can also be preset, and for the auditory skill level greater than the preset level value, the preset task corresponding to the auditory skill level is set. When the auditory skill level of the controlled virtual object reaches the preset level value, the preset task can be unlocked, and only when the preset task corresponding to the auditory skill level is completed, the distance range corresponding to the target skill parameter can be increased.

That is, only when the auditory skill level of the controlled virtual object reaches the preset level value and completes the preset task corresponding to the auditory skill level, the distance range corresponding to the target skill parameter will be increased. After the auditory skill level of the controlled virtual object reaches the preset level value, when the preset task corresponding to the auditory skill level is completed, the distance range corresponding to the target skill parameter will be greater.

Through the above method, a dynamic audible distance (that is, the distance range within which the sound can be heard) can be achieved. As the auditory skill level increases, or the completion status of the preset task corresponding to the auditory skill level changes, the player's audible distance will also change. In addition, it is also achieved that different players have different audible distances in the game.

The following embodiment provides a specific implementation for generating a loudness control parameter.

In response to the controlled virtual object performing a first action, a first action sound corresponding to the first action is determined; and a loudness control parameter of the first action sound is generated based on the target skill parameter, the loudness control parameter is configured to control first playback loudness of the first action sound on a terminal device corresponding to a second virtual object in the game scene, and the second virtual object is the virtual object other than the controlled virtual object.

Specifically, the controlled virtual object can walk, jump, vault, run or perform other actions during the game. In order to increase the authenticity of the game, each action will have a corresponding action sound effect. When the controlled virtual object performs the first action, the first action can be any of the above actions, and the action sound corresponding to the first action is determined. For example, when the first action is walking, the first action sound is the footstep sound. Then, the loudness control parameter of the first action sound is generated according to the target skill parameter. The loudness control parameter is configured to control the first playback loudness of the first action sound on the terminal device corresponding to the second virtual object in the game scene, and the second virtual object is the virtual object other than the controlled virtual object. That is, the loudness control parameter can control the playback loudness of the sound made by the controlled virtual object on other players' devices.

Furthermore, the target skill parameter includes the auditory skill level, and the higher the auditory skill level, the lower the first playback loudness. Specifically, the target skill parameter may include the auditory skill level. When the auditory skill level of the controlled virtual object is higher, the action sound made by the controlled virtual object in the game scene will be played at the lower playback loudness on other players' terminal devices. For example, if the auditory skill level of the controlled virtual object is level 10, the playback loudness of the footstep sound generated when it walks on other players' terminal devices is a, then when the controlled virtual object completes training in the specified sub-scene and the auditory skill level is increased to level 11, the playback loudness of the footstep sound generated when it walks on other players' terminal devices is b. Then, a relationship between a and b is a>b. For another example, if the auditory skill level of the controlled virtual object C is level 15 and the auditory skill level of another controlled virtual object D is level 16, then when the playback loudness of the footstep sound generated when the controlled virtual object C walks on other players' terminal devices will be larger than the playback loudness of the footstep sound generated when the controlled virtual object D walks on other players' terminal devices.

In this method, the magnitude of the first playback loudness is affected by the magnitude of the auditory skill level, and the player corresponding to the controlled virtual object with the high auditory skill level can conceal well in the game and is not easily discovered by other players.

The following embodiments provide a specific implementation for determining the sound playback parameter of the target sound.

The sound playback parameter includes a sound playback type, the target sound is preset with a plurality of sound files, and sound data of corresponding types is stored in the sound files. In response to the sound playback instruction for the target sound, at least part of the sound files to be played is determined, based on the target skill parameter, from the plurality of sound files of the target sound; and the terminal device is controlled to play the determined at least part of the sound files.

In actual implementation, the sound playback parameter may also include the sound playback type, which may be obtained by performing classification according to the sound effect or the source of the sound. The target sound is preset with the plurality of sound files, and the sound files store the sound data of the corresponding types. For example, the sound data such as footstep sounds, jumping sounds, and vaulting sounds made by the body of the virtual object during movement may be stored in one sound file, and the sound data such as firearm sounds and explosion sounds made by the virtual object during combat may be stored in another sound file. Alternatively, the firearm sounds may be further subdivided according to the sound source, for example, sounds emitted by different firearms may be different, and the sounds emitted by the different firearms may be stored in different sound files.

When the sound playback instruction for the target sound is received, the at least part of the sound files to be played is determined, according to the target skill parameter, from the plurality of sound files of the target sound. The number of the determined sound files to be played is associated with the target skill parameter. Then, the terminal device is controlled to play the determined at least part of the sound files.

Furthermore, the target skill parameter includes the auditory skill level; the higher the auditory skill level, the larger the number of the determined sound files. That is, the target skill parameter may include the auditory skill level. The higher the auditory skill level of the controlled virtual object is, the more sound files are determined from the plurality of sound files of the target sound, that is, the player corresponding to the controlled virtual object can hear the more types of sounds. For example, in a certain game scene, there are a plurality of sounds such as the rain sound, the footstep sound, and the firearm sound. Under different target skill parameters, the sound types that the player can hear are also different. For example, when the target skill parameter is very low, the player can only hear the rain sound. When the auditory skill level is relatively low, the player can hear the rain sound and the footstep sound. When the auditory skill level is high, the player can hear the rain sound, the footstep sound, and the firearm sound.

In this method, when the auditory skill level is low, the sound is relatively simple. When the auditory skill level is higher, the sound effect is richer, thereby improving the diversity of the presentation of the sound effect.

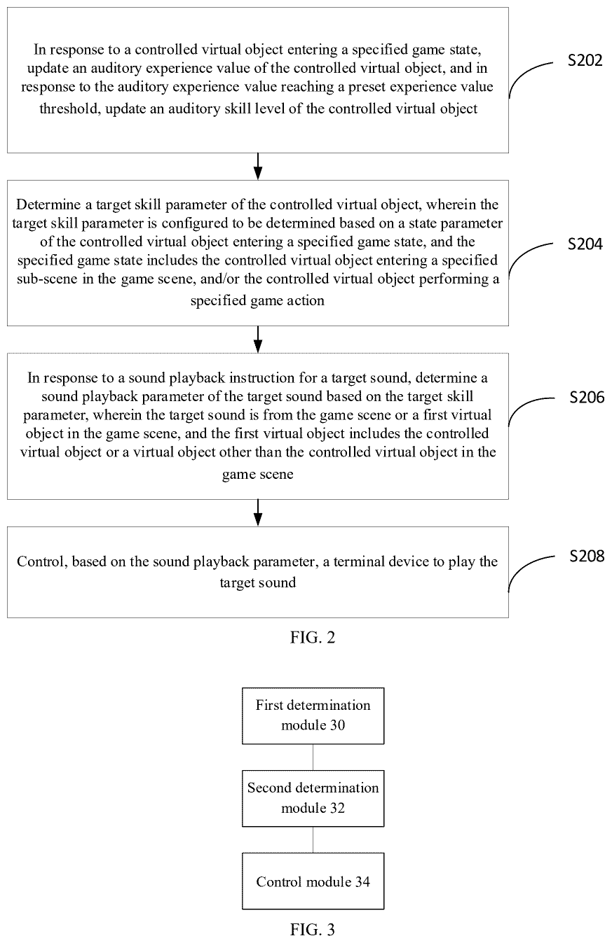

The following embodiments provide another specific implementation for the method for controlling the sound in the game, as shown in FIG. 2.

In step S202, in response to a controlled virtual object entering a specified game state, an auditory experience value of the controlled virtual object is updated, and in response to the auditory experience value reaching a preset experience value threshold, an auditory skill level of the controlled virtual object is updated.

In actual implementation, the target skill parameter may include the auditory skill level. The auditory skill level of the controlled virtual object may start from level 0. When the controlled virtual object enters the specified game state and completes the corresponding training, it may obtain the auditory experience value, and then the auditory experience value of the controlled virtual object is updated. When the auditory experience value reaches the preset experience value threshold, the auditory skill level of the controlled virtual object may be updated until the auditory skill level of the controlled virtual object reaches an upper limit of the level. For example, if the preset experience threshold is 100, an initial auditory skill level of the controlled virtual object is level 0. When the controlled virtual object enters the specified sub-scene in the specified game scene and completes the training, it may obtain the auditory experience value. When the auditory experience value accumulates to 100, the auditory skill level of the controlled virtual object will be upgraded to level 1, and so on, until the auditory skill level of the controlled virtual object is upgraded to the upper limit of the level.

It should be noted that when the auditory skill level is improved, the preset experience threshold may be the same or different. For example, the preset experience threshold may increase as the auditory skill level increases. For example, when the auditory skill level of the controlled virtual object is improved from level 0 to level 1, the preset experience threshold is 100, and when the auditory skill level is improved from level 1 to level 2, the preset experience threshold may be 100 or greater than 100.

In the embodiment, the auditory skill level of the controlled virtual object is updated according to the training result of the player in the specified game state, so that auditory skill levels of different players in the game are different, and the game experience at different auditory levels can be further obtained.

In step S204, a target skill parameter of the controlled virtual object is determined, the target skill parameter is configured to be determined based on a state parameter of the controlled virtual object entering a specified game state, and the specified game state includes that the controlled virtual object enters a specified sub-scene in the game scene, and/or the controlled virtual object performs a specified game action.

In step S206, in response to a sound playback instruction for a target sound, a sound playback parameter of the target sound is determined based on the target skill parameter, the target sound is from the game scene or a first virtual object in the game scene, and the first virtual object includes the controlled virtual object or a virtual object other than the controlled virtual object in the game scene.

In step S208, the terminal device is controlled, based on the sound playback parameter, to play the target sound.

The above steps S204 to S208 are the same as the steps S102 to S106, which will not be described in detail herein.

For the above method embodiments, reference is made a schematic structural diagram of a device for controlling a sound in a game shown in FIG. 3. A graphical user interface is provided by a terminal device, the graphical user interface includes a scene screen of a game scene, a controlled virtual object is located in the game scene, and the controlled virtual object is controlled through the terminal device. The device includes:
a first determination module 30, configured to determine a target skill parameter of the controlled virtual object, where the target skill parameter is configured to be determined based on a state parameter of the controlled virtual object entering a specified game state, and the specified game state includes the controlled virtual object entering a specified sub-scene in the game scene and/or the controlled virtual object performing a specified game action;
a second determination module 32, configured to, in response to a sound playback instruction for a target sound, determine a sound playback parameter of the target sound based on the target skill parameter, where the target sound is from the game scene or a first virtual object in the game scene, and the first virtual object includes the controlled virtual object or a virtual object other than the controlled virtual object in the game scene; and
a control module 34 is configured to control, based on the sound playback parameter, the terminal device to play the target sound.

In the device for controlling the sound in the game as described above, the target skill parameter of the controlled virtual object is determined, the target skill parameter is configured to be determined based on the state parameter of the controlled virtual object entering the specified game state, and the specified game state includes that the controlled virtual object enters the specified sub-scene in the game scene, and/or the controlled virtual object performs the specified game action; in response to the sound playback instruction for the target sound, the sound playback parameter of the target sound is determined based on the target skill parameter, the target sound is from the game scene or the first virtual object in the game scene, and the first virtual object includes the controlled virtual object or the virtual object other than the controlled virtual object in the game scene; and the terminal device is controlled, based on the sound playback parameter, to play the target sound. In this way, the target skill parameter is determined according to the state parameter of the controlled virtual object entering the specified game state, so that different players can have different target skill parameters, and the target skill parameter is associated with the sound playback parameter of the target sound, so that different players hear different sound effects for the same sound, which enriches the presentation of the sound effect, realizes a differentiated auditory experience, and improves the game experience of the player.

The specified game state includes the controlled virtual object entering the specified sub-scene in the game scene, the specified sub-scene includes a preset skill training sub-scene, and the device further includes a first update module, configured to control the controlled virtual object to enter the skill training sub-scene; in response to the controlled virtual object entering the skill training sub-scene, obtain, based on a state of the controlled virtual object in the skill training sub-scene, a skill training parameter of the controlled virtual object; and update the target skill parameter of the controlled virtual object based on the skill training parameter.

The specified game state includes the controlled virtual object performing the specified game action, and the device further includes a second update module, configured to, in response to an action control operation, control the controlled virtual object to perform the specified game action; and obtain an action parameter of the controlled virtual object for performing the specified game action, and update the target skill parameter of the controlled virtual object based on the action parameter, where the action parameter includes an action duration and/or the number of times of the action.

The target skill parameter includes an auditory skill level, and the device further includes a third update module, configured to, in response to the controlled virtual object entering the specified game state, update an auditory experience value of the controlled virtual object; and in response to the auditory experience value reaching a preset experience value threshold, update an auditory skill level of the controlled virtual object.

The sound playback parameter includes sound playback loudness, and the second determination module is further configured to receive the sound playback instruction for the target sound, and determine a sound attribute of the target sound, where the sound attribute indicates a sound source and/or a sound type of the target sound; and determine sound playback loudness of the target sound based on the sound attribute of the target sound and the target skill parameter.

The target skill parameter includes an auditory skill level, and a sound type of the target sound indicated by the sound attribute is an environmental noise of the game scene; and the higher the auditory skill level, the lower the sound playback loudness of the target sound.

The target skill parameter includes an auditory skill level, and a sound type of the target sound indicated by the sound attribute is an action sound of the controlled virtual object; and the higher the auditory skill level, the lower the sound playback loudness of the target sound.

The second determination module is further configured to determine a distance parameter between a sound source of the target sound and the controlled virtual object, where the sound source includes the virtual object other than the controlled virtual object in the game scene; if the distance parameter is within a distance range corresponding to the target skill parameter, determine that the sound playback loudness of the target sound is first loudness; and if the distance parameter is outside the distance range corresponding to the target skill parameter, determine that the sound playback loudness of the target sound is zero.

The target skill parameter includes an auditory skill level, and if the distance parameter is within the distance range corresponding to the target skill parameter, the higher the auditory skill level, the higher the first loudness.

If the distance parameter is within the distance range corresponding to the target skill parameter, the smaller the distance parameter, the higher the first loudness.

The target skill parameter includes an auditory skill level, the higher the auditory skill level, the larger the distance range corresponding to the target skill parameter, and/or the distance range corresponding to the target skill parameter is associated with a completion status of a preset task corresponding to the auditory skill level.

The device further includes a generation module, configured to, in response to the controlled virtual object performing a first action, determine a first action sound corresponding to the first action; and generate, based on the target skill parameter, a loudness control parameter of the first action sound, where the loudness control parameter is configured to control first playback loudness of the first action sound on a terminal device corresponding to a second virtual object in the game scene, and the second virtual object is the virtual object other than the controlled virtual object.

The target skill parameter includes an auditory skill level, and the higher the auditory skill level, the lower the first playback loudness.

The sound playback parameter includes a sound playback type, the target sound is preset with a plurality of sound files, and sound data of corresponding types is stored in the sound files; and the second determination module is further configured to, in response to the sound playback instruction for the target sound, determine, based on the target skill parameter, at least part of the sound files to be played from the plurality of sound files of the target sound; and control the terminal device to play the determined at least part of the sound files.

The target skill parameter includes an auditory skill level, and the higher the auditory skill level, the larger the number of the determined sound files.

Embodiments of the present disclosure further provide an electronic device, including a processor and a memory. Machine-executable instructions that can be executed by the processor are stored in the memory, and the processor executes the machine-executable instructions to implement the method for controlling the sound in the game as described above. The electronic device can be a server or a touch terminal device.

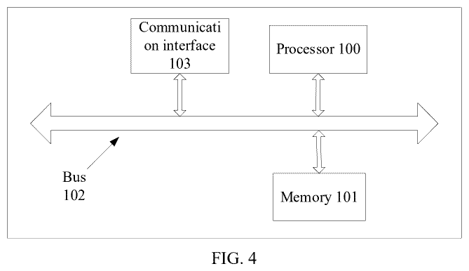

As shown in FIG. 4, the electronic device includes a processor 100 and a memory 101. The memory 101 stores machine-executable instructions that can be executed by the processor 100. The processor 100 executes the machine-executable instructions to implement the method for controlling the sound in the game as described above.

Furthermore, the electronic device shown in FIG. 4 further includes a bus 102 and a communication interface 103. The processor 100, the communication interface 103 and the memory 101 are connected via the bus 102.

The memory 101 may include a high-speed random access memory (RAM), and may also include a non-volatile memory, such as, at least one disk storage. The communication connection between the system network element and at least one other network element is realized through at least one communication interface 103 (which can be wired or wireless), and the Internet, the wide area network, the local area network, the metropolitan area network, etc. can be used. The bus 102 can be an ISA bus, a PCI bus or an EISA bus, etc. The bus can be divided into an address bus, a data bus, a control bus, etc. For ease of representation, only one bidirectional arrow is used in FIG. 4, but it does not mean that there is only one bus or one type of bus.

The processor 100 may be an integrated circuit chip with signal processing capabilities. In an implementation process, each step of the above method can be completed by a hardware integrated logic circuit or software instructions in the processor 100. The processor 100 may be a general-purpose processor, including a central processing unit (CPU), a network processor (NP), etc.; it can also be a digital signal processor (DSP), an application specific integrated circuit (ASIC), a field-programmable gate array (FPGA) or other programmable logic devices, discrete gates or transistor logic devices, discrete hardware components. The disclosed methods, steps and logic block diagrams in embodiments of the present disclosure can be implemented or executed. The general-purpose processor can be a microprocessor or the processor can also be any conventional processor, etc. The steps of the method disclosed in conjunction with the embodiments of the present disclosure can be directly embodied as a hardware decoding processor for execution, or a combination of hardware and software modules in the decoding processor for execution. The software module may be located in a storage medium mature in the art, such as a random access memory, a flash memory, a read-only memory, a programmable read-only memory, or an electrically erasable programmable memory, a register, etc. The storage medium is located in the memory 101, and the processor 100 reads the information in the memory 101 and completes the steps of the method of the above embodiments in combination with its hardware.

The processor in the electronic device can implement, by executing the machine-executable instructions, the following operations in the method for controlling the sound in the game:
determining a target skill parameter of the controlled virtual object, where the target skill parameter is configured to be determined based on a state parameter of the controlled virtual object entering a specified game state, and the specified game state includes the controlled virtual object entering a specified sub-scene in the game scene and/or the controlled virtual object performing a specified game action; in response to a sound playback instruction for a target sound, determining a sound playback parameter of the target sound based on the target skill parameter, where the target sound is from the game scene or a first virtual object in the game scene, and the first virtual object includes the controlled virtual object or a virtual object other than the controlled virtual object in the game scene; and controlling, based on the sound playback parameter, the terminal device to play the target sound.

In this way, the target skill parameter is determined according to the state parameter of the controlled virtual object entering the specified game state, so that different players can have different target skill parameters, and the target skill parameter is associated with the sound playback parameter of the target sound, so that different players hear different sound effects for the same sound, which enriches the presentation of the sound effect, realizes a differentiated auditory experience, and improves the game experience of the player.

The specified game state includes that the controlled virtual object enters the specified sub-scene in the game scene, and the specified sub-scene includes a preset skill training sub-scene. The controlled virtual object is controlled to enter the skill training sub-scene; in response to the controlled virtual object entering the skill training sub-scene, a skill training parameter of the controlled virtual object is obtained based on a state of the controlled virtual object in the skill training sub-scene; and the target skill parameter of the controlled virtual object is updated based on the skill training parameter.

The specified game state includes that the controlled virtual object performs the specified game action, and in response to an action control operation, the controlled virtual object is controlled to perform the specified game action; and an action parameter of the controlled virtual object for performing the specified game action is obtained, and the target skill parameter of the controlled virtual object is updated based on the action parameter, the action parameter includes an action duration and/or the number of times of the action.

The target skill parameter includes an auditory skill level. In response to the controlled virtual object entering the specified game state, an auditory experience value of the controlled virtual object is updated; and in response to the auditory experience value reaching a preset experience value threshold, the auditory skill level of the controlled virtual object is updated.

In the embodiment, the auditory skill level of the controlled virtual object is updated according to the training result of the player in the specified game state, so that auditory skill levels of different players in the game are different, and the game experience at different auditory levels can be further obtained.

The sound playback parameter includes sound playback loudness. The sound playback instruction for the target sound is received, and a sound attribute of the target sound is determined, the sound attribute indicates a sound source and/or a sound type of the target sound; and sound playback loudness of the target sound is determined based on the sound attribute of the target sound and the target skill parameter.

The target skill parameter includes an auditory skill level, and a sound type of the target sound indicated by the sound attribute is an environmental noise of the game scene; and the higher the auditory skill level, the lower the sound playback loudness of the target sound.

The target skill parameter includes an auditory skill level, and a sound type of the target sound indicated by the sound attribute is an action sound of the controlled virtual object; and the higher the auditory skill level, the lower the sound playback loudness of the target sound.

A distance parameter between a sound source of the target sound and the controlled virtual object is determined, and the sound source includes the virtual object other than the controlled virtual object in the game scene. If the distance parameter is within a distance range corresponding to the target skill parameter, it is determined that the sound playback loudness of the target sound is first loudness. If the distance parameter is outside the distance range corresponding to the target skill parameter, it is determined that the sound playback loudness of the target sound is zero.

The target skill parameter includes an auditory skill level, and if the distance parameter is within the distance range corresponding to the target skill parameter, the higher the auditory skill level, the higher the first loudness.

In the embodiment, in the game scene, when other virtual objects make sounds, for multiple players within the audible distance range, players corresponding to virtual objects with different auditory skill levels hear the target sound at the different loudness, thereby creating a differentiated auditory experience.

If the distance parameter is within the distance range corresponding to the target skill parameter, the smaller the distance parameter, the higher the first loudness.

The target skill parameter includes an auditory skill level, the higher the auditory skill level, the larger the distance range corresponding to the target skill parameter, and/or the distance range corresponding to the target skill parameter is associated with a completion status of a preset task corresponding to the auditory skill level.

Through the above method, a dynamic audible distance (the distance range within which the sound can be heard) can be achieved. As the auditory skill level increases, or the completion status of the preset task corresponding to the auditory skill level changes, the player's audible distance will also change. In addition, it is also achieved that different players have different audible distances in the game.

In response to the controlled virtual object performing a first action, a first action sound corresponding to the first action is determined; and a loudness control parameter of the first action sound is generated based on the target skill parameter, the loudness control parameter is configured to control first playback loudness of the first action sound on a terminal device corresponding to a second virtual object in the game scene, and the second virtual object is the virtual object other than the controlled virtual object.

The target skill parameter includes the auditory skill level, and the higher the auditory skill level, the lower the first playback loudness.

In this method, the magnitude of the first playback loudness is affected by the magnitude of the auditory skill level, and the player corresponding to the controlled virtual object with the high auditory skill level can conceal well in the game and is not easily discovered by other players.

The sound playback parameter includes a sound playback type, the target sound is preset with a plurality of sound files, and sound data of corresponding types is stored in the sound files. In response to the sound playback instruction for the target sound, at least part of the sound files to be played is determined, based on the target skill parameter, from the plurality of sound files of the target sound; and the terminal device is controlled to play the determined at least part of the sound files.

The target skill parameter includes the auditory skill level; the higher the auditory skill level, the larger the number of the determined sound files.

In this method, when the auditory skill level is low, the sound is relatively simple. When the auditory skill level is higher, the sound effect is richer, thereby improving the diversity of the presentation of the sound effect.

Embodiments of the present disclosure further provide a non-transitory machine-readable storage medium having machine-executable instructions stored thereon, which, when invoked and executed by a processor, cause the processor to implement the method for controlling the sound in the game as described above.

The machine-executable instructions stored in the machine readable storage medium can implement, by executing the machine-executable instructions, the following operations in the method for controlling the sound in the game:
determining a target skill parameter of the controlled virtual object, where the target skill parameter is configured to be determined based on a state parameter of the controlled virtual object entering a specified game state, and the specified game state includes the controlled virtual object entering a specified sub-scene in the game scene and/or the controlled virtual object performing a specified game action; in response to a sound playback instruction for a target sound, determining a sound playback parameter of the target sound based on the target skill parameter, where the target sound is from the game scene or a first virtual object in the game scene, and the first virtual object includes the controlled virtual object or a virtual object other than the controlled virtual object in the game scene; and controlling, based on the sound playback parameter, the terminal device to play the target sound.

In this way, the target skill parameter is determined according to the state parameter of the controlled virtual object entering the specified game state, so that different players can have different target skill parameters, and the target skill parameter is associated with the sound playback parameter of the target sound, so that different players hear different sound effects for the same sound, which enriches the presentation of the sound effect, realizes a differentiated auditory experience, and improves the game experience of the player.

The specified game state includes that the controlled virtual object enters the specified sub-scene in the game scene, and the specified sub-scene includes a preset skill training sub-scene. The controlled virtual object is controlled to enter the skill training sub-scene; in response to the controlled virtual object entering the skill training sub-scene, a skill training parameter of the controlled virtual object is obtained based on a state of the controlled virtual object in the skill training sub-scene; and the target skill parameter of the controlled virtual object is updated based on the skill training parameter.

The specified game state includes that the controlled virtual object performs the specified game action, and in response to an action control operation, the controlled virtual object is controlled to perform the specified game action; and an action parameter of the controlled virtual object for performing the specified game action is obtained, and the target skill parameter of the controlled virtual object is updated based on the action parameter, the action parameter includes an action duration and/or the number of times of the action.

The target skill parameter includes an auditory skill level. In response to the controlled virtual object entering the specified game state, an auditory experience value of the controlled virtual object is updated; and in response to the auditory experience value reaching a preset experience value threshold, the auditory skill level of the controlled virtual object is updated.

In the embodiment, the auditory skill level of the controlled virtual object is updated according to the training result of the player in the specified game state, so that auditory skill levels of different players in the game are different, and the game experience at different auditory levels can be further obtained.

The sound playback parameter includes sound playback loudness. The sound playback instruction for the target sound is received, and a sound attribute of the target sound is determined, the sound attribute indicates a sound source and/or a sound type of the target sound; and sound playback loudness of the target sound is determined based on the sound attribute of the target sound and the target skill parameter.

The target skill parameter includes an auditory skill level, and a sound type of the target sound indicated by the sound attribute is an environmental noise of the game scene; and the higher the auditory skill level, the lower the sound playback loudness of the target sound.

The target skill parameter includes an auditory skill level, and a sound type of the target sound indicated by the sound attribute is an action sound of the controlled virtual object; and the higher the auditory skill level, the lower the sound playback loudness of the target sound.

A distance parameter between a sound source of the target sound and the controlled virtual object is determined, and the sound source includes the virtual object other than the controlled virtual object in the game scene. If the distance parameter is within a distance range corresponding to the target skill parameter, it is determined that the sound playback loudness of the target sound is first loudness. If the distance parameter is outside the distance range corresponding to the target skill parameter, it is determined that the sound playback loudness of the target sound is zero.

The target skill parameter includes an auditory skill level, and if the distance parameter is within the distance range corresponding to the target skill parameter, the higher the auditory skill level, the higher the first loudness.

In the embodiment, in the game scene, when other virtual objects make sounds, for multiple players within the audible distance range, players corresponding to virtual objects with different auditory skill levels hear the target sound at the different loudness, thereby creating a differentiated auditory experience.

If the distance parameter is within the distance range corresponding to the target skill parameter, the smaller the distance parameter, the higher the first loudness.

The target skill parameter includes an auditory skill level, the higher the auditory skill level, the larger the distance range corresponding to the target skill parameter, and/or the distance range corresponding to the target skill parameter is associated with a completion status of a preset task corresponding to the auditory skill level.

Through the above method, a dynamic audible distance (the distance range within which the sound can be heard) can be achieved. As the auditory skill level increases, or the completion status of the preset task corresponding to the auditory skill level changes, the player's audible distance will also change. In addition, it is also achieved that different players have different audible distances in the game.

In response to the controlled virtual object performing a first action, a first action sound corresponding to the first action is determined; and a loudness control parameter of the first action sound is generated based on the target skill parameter, the loudness control parameter is configured to control first playback loudness of the first action sound on a terminal device corresponding to a second virtual object in the game scene, and the second virtual object is the virtual object other than the controlled virtual object.

The target skill parameter includes the auditory skill level, and the higher the auditory skill level, the lower the first playback loudness.

In this method, the magnitude of the first playback loudness is affected by the magnitude of the auditory skill level, and the player corresponding to the controlled virtual object with the high auditory skill level can conceal well in the game and is not easily discovered by other players.

The sound playback parameter includes a sound playback type, the target sound is preset with a plurality of sound files, and sound data of corresponding types is stored in the sound files. In response to the sound playback instruction for the target sound, at least part of the sound files to be played is determined, based on the target skill parameter, from the plurality of sound files of the target sound; and the terminal device is controlled to play the determined at least part of the sound files.

The target skill parameter includes the auditory skill level; the higher the auditory skill level, the larger the number of the determined sound files.

In this method, when the auditory skill level is low, the sound is relatively simple. When the auditory skill level is higher, the sound effect is richer, thereby improving the diversity of the presentation of the sound effect.

A computer program product of the method and device for controlling the sound in the game, and the electronic device provided in embodiments of the present disclosure includes a computer-readable storage medium storing program codes. Instructions included in the program codes can be configured to execute the method described in the previous method embodiments. For the specific implementation, reference can be made to the method embodiments, which will not be repeated here.

Those skilled in the art can clearly understand that, for the convenience and brevity of description, the specific working process of the system and device described above can refer to the corresponding process in the aforementioned method embodiments, which will not be repeated here.

In addition, in the description of embodiments of the present disclosure, unless otherwise clearly specified and limited, the terms “installed”, “connected”, and “coupled” should be understood in a broad sense, for example, it can be a fixed connection, a detachable connection, or an integral connection; it can be a mechanical connection or an electrical connection; it can be a direct connection, or it can be indirectly connected through an intermediate medium, or it can be the internal communication of two components. For those skilled in the art, the specific meanings of the above terms in the present disclosure can be understood according to specific circumstances.

The functions may be stored in a computer readable storage medium if implemented in the form of a software functional unit and sold or used as a standalone product. Based on such understanding, the technical solutions of the present disclosure substantially, or the part contributing to the prior art, or all or a part of the technical solutions may be implemented in the form of a software product, the computer software product is stored in a storage medium, and includes a plurality of instructions enabling a computer device (which may be a personnel computer, a server, or a network device, etc.) to execute all or a part of the steps of the methods in embodiments of the present disclosure. The foregoing storage medium includes a variety of media capable of storing program codes, such as a USB disk, a mobile hard disk, a read-only memory (ROM), a random access memory (RAM), a magnetic disk, an optical disk or the like.

In the description of the present disclosure, it should be noted that the terms “center”, “upper”, “lower”, “left”, “right”, “vertical”, “horizontal”, “inner”, “outer”, etc., indicating the orientation or positional relationship, are based on the orientation or positional relationship shown in the drawings, and are only for the convenience of describing the present disclosure and simplifying the description, rather than indicating or implying that the device or element referred to must have a specific orientation, be constructed and operated in a specific orientation, and therefore cannot be understood as a limitation of the present disclosure. In addition, the terms “first”, “second”, and “third” are used for descriptive purposes only, and cannot be understood as indicating or implying relative importance.

Finally, it should be noted that the above-mentioned embodiments are only specific embodiments of the present disclosure, and are used to illustrate the technical solutions of the present disclosure, but not to limit them. The protection scope of the present disclosure is not limited thereto, although the present disclosure has been described in detail with reference to the foregoing embodiments, those ordinarily skilled in the art should understand that: any person skilled in the art who is familiar with the technical field can still make modifications or can easily think of changes to the technical solutions described in the foregoing embodiments within the technical scope disclosed by the present disclosure, or perform equivalent replacements to some of the technical features thereof; and these modifications, changes or substitutions do not make the essence of the corresponding technical solutions deviate from the spirit and scope of the technical solutions in the embodiments of the present disclosure. All should be included within the protection scope of the present disclosure. Therefore, the protection scope of the present disclosure shall be subject to the protection scope of the claims.

1. A method for controlling a sound in a game, comprising:
determining a target skill parameter of a controlled virtual object in a game scene displayed in a graphical user interface of a terminal device, wherein the target skill parameter is configured to be determined based on a state parameter of the controlled virtual object entering a specified game state, and the specified game state comprises at least one of the controlled virtual object entering a specified sub-scene in the game scene or the controlled virtual object performing a specified game action, wherein the controlled virtual object is controlled through the terminal device;
in response to a sound playback instruction for a target sound, determining a sound playback parameter of the target sound based on the target skill parameter, wherein the target sound is from the game scene or a first virtual object in the game scene, and the first virtual object comprises the controlled virtual object or a virtual object other than the controlled virtual object in the game scene; and
controlling, based on the sound playback parameter, the terminal device to play the target sound.

2. The method according to claim 1, wherein the specified game state comprises the controlled virtual object entering the specified sub-scene in the game scene, the specified sub-scene comprises a preset skill training sub-scene, and the method further comprises:
controlling the controlled virtual object to enter the skill training sub-scene;
in response to the controlled virtual object entering the skill training sub-scene, obtaining, based on a state of the controlled virtual object in the skill training sub-scene, a skill training parameter of the controlled virtual object; and
updating the target skill parameter of the controlled virtual object based on the skill training parameter.

3. The method according to claim 1, wherein the specified game state comprises the controlled virtual object performing the specified game action, and the method further comprises:
in response to an action control operation, controlling the controlled virtual object to perform the specified game action; and
obtaining an action parameter of the controlled virtual object for performing the specified game action, and updating the target skill parameter of the controlled virtual object based on the action parameter, wherein the action parameter comprises at least one of an action duration and/or the number of times of the action.

4. The method according to claim 1, wherein the target skill parameter comprises an auditory skill level, and the method further comprises:
in response to the controlled virtual object entering the specified game state, updating an auditory experience value of the controlled virtual object; and
in response to the auditory experience value reaching a preset experience value threshold, updating an auditory skill level of the controlled virtual object.

5. The method according to claim 1, wherein the sound playback parameter comprises sound playback loudness, and in response to the sound playback instruction for the target sound, determining the sound playback parameter of the target sound based on the target skill parameter comprises:
receiving the sound playback instruction for the target sound, and determining a sound attribute of the target sound, wherein the sound attribute indicates at least one of a sound source and/or a sound type of the target sound; and
determining sound playback loudness of the target sound based on the sound attribute of the target sound and the target skill parameter.

6. The method according to claim 5, wherein the target skill parameter comprises an auditory skill level, and a sound type of the target sound indicated by the sound attribute is an environmental noise of the game scene; and
the higher the auditory skill level, the lower the sound playback loudness of the target sound.

7. The method according to claim 5, wherein the target skill parameter comprises an auditory skill level, and a sound type of the target sound indicated by the sound attribute is an action sound of the controlled virtual object; and
the higher the auditory skill level, the lower the sound playback loudness of the target sound.

8. The method according to claim 5, wherein determining the sound playback loudness of the target sound based on the sound attribute of the target sound and the target skill parameter comprises:
determining a distance parameter between a sound source of the target sound and the controlled virtual object, wherein the sound source comprises the virtual object other than the controlled virtual object in the game scene;
in response to detecting that the distance parameter is within a distance range corresponding to the target skill parameter, determining that the sound playback loudness of the target sound is first loudness; and
in response to detecting that the distance parameter is outside the distance range corresponding to the target skill parameter, determining that the sound playback loudness of the target sound is zero.

9. The method according to claim 8, wherein the target skill parameter comprises an auditory skill level, and in response to detecting that the distance parameter is within the distance range corresponding to the target skill parameter, the higher the auditory skill level, the higher the first loudness.

10. The method according to claim 8, wherein in response to detecting that the distance parameter is within the distance range corresponding to the target skill parameter, the smaller the distance parameter, the higher the first loudness.

11. The method according to claim 8, wherein the target skill parameter comprises an auditory skill level, the higher the auditory skill level, the larger the distance range corresponding to the target skill parameter, and/or the distance range corresponding to the target skill parameter is associated with a completion status of a preset task corresponding to the auditory skill level.

12. The method according to claim 1, wherein the method further comprises:
in response to the controlled virtual object performing a first action, determining a first action sound corresponding to the first action; and
generating, based on the target skill parameter, a loudness control parameter of the first action sound, wherein the loudness control parameter is configured to control first playback loudness of the first action sound on a terminal device corresponding to a second virtual object in the game scene, and the second virtual object is the virtual object other than the controlled virtual object.

13. The method according to claim 12, wherein the target skill parameter comprises an auditory skill level, and the higher the auditory skill level, the lower the first playback loudness.

14. The method according to claim 1, wherein the sound playback parameter comprises a sound playback type, the target sound is preset with a plurality of sound files, and sound data of corresponding types is stored in the sound files; and
in response to the sound playback instruction for the target sound, determining the sound playback parameter of the target sound based on the target skill parameter comprises:
in response to the sound playback instruction for the target sound, determining, based on the target skill parameter, at least part of the sound files to be played from the plurality of sound files of the target sound; and
controlling the terminal device to play the determined at least part of the sound files.

15. The method according to claim 14, wherein the target skill parameter comprises an auditory skill level, and the higher the auditory skill level, the larger the number of the determined sound files.

16. (canceled)

17. An electronic device, comprising a processor and a memory, wherein machine-executable instructions that are capable of being executed by the processor are stored in the memory, and the processor executes the machine-executable instructions to implement the following operations:
determining a target skill parameter of a controlled virtual object in a game scene displayed in a graphical user interface of the electronic device, wherein the target skill parameter is configured to be determined based on a state parameter of the controlled virtual object entering a specified game state, and the specified game state comprises at least one of the controlled virtual object entering a specified sub-scene in the game scene or the controlled virtual object performing a specified game action, wherein the controlled virtual object is controlled through the electronic device;
in response to a sound playback instruction for a target sound, determining a sound playback parameter of the target sound based on the target skill parameter, wherein the target sound is from the game scene or a first virtual object in the game scene, and the first virtual object comprises the controlled virtual object or a virtual object other than the controlled virtual object in the game scene; and
controlling, based on the sound playback parameter, the electronic device to play the target sound.

18. A non-transitory machine-readable storage medium having machine-executable instructions stored thereon, wherein the machine-executable instructions, when invoked and executed by a processor, cause the processor to implement the following operations:
determining a target skill parameter of a controlled virtual object in a game scene displayed in a graphical user interface of a terminal device, wherein the target skill parameter is configured to be determined based on a state parameter of the controlled virtual object entering a specified game state, and the specified game state comprises at least one of the controlled virtual object entering a specified sub-scene in the game scene or the controlled virtual object performing a specified game action, wherein the controlled virtual object is controlled through the terminal device;
in response to a sound playback instruction for a target sound, determining a sound playback parameter of the target sound based on the target skill parameter, wherein the target sound is from the game scene or a first virtual object in the game scene, and the first virtual object comprises the controlled virtual object or a virtual object other than the controlled virtual object in the game scene; and
controlling, based on the sound playback parameter, the terminal device to play the target sound.

19. The method according to claim 4, wherein the auditory skill level of the controlled virtual object is further associated with a character level of the controlled virtual object.

20. The method according to claim 5, wherein the sound playback loudness of the target sound is further associated with a game plot where the controlled virtual object is located.

21. The electronic device according to claim 17, wherein the wherein the specified game state comprises the controlled virtual object entering the specified sub-scene in the game scene, the specified sub-scene comprises a preset skill training sub-scene, and the processor is further configured to implement the following operations:
controlling the controlled virtual object to enter the skill training sub-scene;
in response to the controlled virtual object entering the skill training sub-scene, obtaining, based on a state of the controlled virtual object in the skill training sub-scene, a skill training parameter of the controlled virtual object; and
updating the target skill parameter of the controlled virtual object based on the skill training parameter.
